(19) United States
(12) Patent Application Publication
(10) Pub. No.: US 2020/0013047 A1
(43) Pub. Date: Jan. 9, 2020

(54) METHOD AND DEVICE FOR PROCESSING A PAYMENT TRANSACTION USING A CRYPTOCURRENCY WALLET

(71) Applicant: Robert Bosch GmbH, Stuttgart (DE)

(72) Inventors: Simon Weissenmayer, Flein (DE); Peter Busch, Ludwigsburg (DE); Rouven Ritter, Stuttgart (DE); Steffen Eccarius, Stuttgart (DE)

(21) Appl. No.: 16/451,876

(22) Filed: Jun. 25, 2019

(30) Foreign Application Priority Data
Jul. 3, 2018 (DE) 102018210936.2

(51) Int. Cl. G06Q 20/36; G06Q 20/40

(52) U.S. Cl. CPC G06Q 20/3678; G06Q 2220/00; G06Q 20/4016

(57) ABSTRACT

A method is described for processing a payment transaction using a cryptocurrency wallet. The method involves the following features: an operating state profile of a vehicle is called up, the address is subjected to a plausibility check based on the operating state profile, and a release of the payment transaction is granted if the address bears up against the plausibility check.

### FIELD OF THE INVENTION

The present invention relates to a method for processing a payment transaction using a cryptocurrency wallet. The present invention also relates to a corresponding device, to a corresponding computer program, as well as to a corresponding memory medium.

### BACKGROUND INFORMATION

A so-called cryptocurrency wallet stores the public and private keys required for earning or spending units of cryptocurrency. Cryptocurrency wallets according to the related art may contain multiple pairs of public and private keys. In the case of the cryptocurrency bitcoin and its derivatives, the actual cryptocurrency, however, is recorded decentrally in a publicly accessible ledger. Each unit of the cryptocurrency possesses a private key, which allows the unit to be virtually “spent” through the addition of a payment transaction in this distributed ledger.

So-called hardware wallets (HW-wallets), in particular, are known. When the user of such a wallet processes a payment, the actual payment transaction is created with the aid of an application programming interface (API) of the wallet. The hardware of the wallet then signs the transaction and provides a public key which, in turn, is sent with the aid of the API over the Internet. In this way, the signature keys never leave the hardware wallet.

German Published Patent Application No. 102016206916 relates to an electronic method for transferring an amount of cryptocurrency in a cryptographically secured manner via a transaction of the amount from an output address assigned to a first client to a destination address assigned to a second client, a plurality of clients being provided, which include at least the first client and the second client, one wallet program each being installed on the clients for implementing a client node of the cryptocurrency, a transaction server being provided on which a transaction program for implementing a server node of the cryptocurrency is installed, the transaction program being configured to generate blocks of the blockchain with transaction dates, the transaction server including a private server key and a public server key of an asymmetrical server key pair, and the transaction server including a server certificate of a hierarchical PKI with a central root certification entity, which is configured to serve as proof of the authenticity of the public server key and of the authority of the transaction server to generate blocks of the blockchain.

### SUMMARY

The method provided is based on the finding that in the case of cryptocurrencies, in general, an arbitrary number of addresses may be generated to which the money may be transferred. The character sequence of the addresses may appear random at first glance, but they invariably have a direct connection to a secret key.

The approach described below further takes the desire of numerous users to better secure transfers using cryptocurrencies into account. In particular, the unintentional channeling of transfers (for example, by hackers) to accounts outside of the host jurisdiction is to be avoided and, as a result of which the money is retrievable only with difficulty by recourse to legal action. Ideally, it should be possible to check with the aid of simple means whether a transfer address is plausible.

Against this background, the present invention provides a method for processing a payment transaction using a cryptocurrency wallet, a corresponding device, a corresponding computer program as well as a corresponding memory medium.

One advantage of this approach is its suitability for significantly hampering hacker attacks aimed at stealing money. Thus, hackers have little prospect of success in slipping buyers a falsified transfer address since, according to the present invention, the plausibility of the transfer address is checked based on past operating states of the vehicle. In order for an attack to be able to succeed, a transfer address would initially have to be generated in a costly and tedious process, which would appear plausible to potential victims in view of the expected profile of the operating states of the vehicle.

It may be provided that the address of the payee is generated by repeatedly ascertaining a scatter value of different random numbers and of the secret key until this key codes, according to a predefined scheme, the operating state profile typical for a performance of the buyer functions of potential customers. For service providers, it may prove profitable to generate random secret keys in this manner and to therefore generate random transfer addresses until one of the transfer addresses includes this piece of information. If the issuer of the address is a trustworthy enterprise, customers who believe the issuer that the offered key has actually been kept secret and is accessible only to the buyer, will be found for this transfer address and for the secret key. It would be far more complicated for this customer to generate a secret key him/herself having a correspondingly suitable buyer profile, since with each attempt, the probability of generating an address that is incompatible with his/her goods or services portfolio far outweighs the probability of success. Moreover, the customer will not be able to sell keys unsuitable for him/herself to providers from other business sectors if he/she is unable to convey the trust in his/her ability to actually keep the secret key a secret.

### BRIEF DESCRIPTION OF THE DRAWINGS

FIG. 1 shows a flowchart of a method according to a first specific embodiment.

FIG. 2 schematically shows a cryptocurrency wallet according to a second specific embodiment.

### DETAILED DESCRIPTION

According to the present invention, transfer addresses (hashes) for the account of a seller are generated per attempt and error until an address could be found, which codes according to a predefined scheme the operating state profile of the customers' vehicles typical for a performance of the buyer functions of potential customers.

The more decimal digits relating to operating states a transfer address according to one specific embodiment of the present invention contains, the greater are the costs and effort for generating this address. This suggests, in turn, that the address is used more frequently due to the high costs for generating it and ultimately the greater the trustworthiness is of the address structured in such a way.

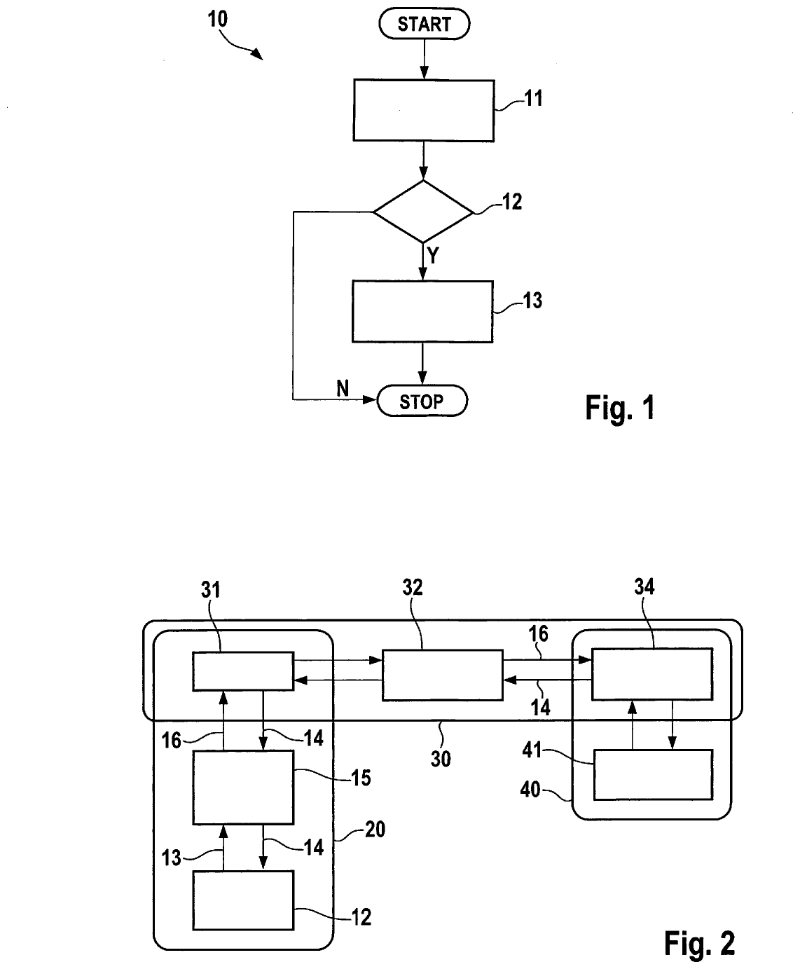

FIG. 1 shows the basic sequence of a method 10 according to the present invention in a use scenario according to FIG. 2: an HW wallet 20 detects selected vehicle data (process 11—FIG. 1) and checks whether the profiles of these vehicle data correspond to particular expected values (process 12—FIG. 1). The expected values for checking the profiles are selected as a function of a code within transfer address 14.

When vehicle 30 is delivered a transfer address 14, it then checks whether a known digit sequence having associated expected values of vehicle data is stored in an internal table, as is illustrated by way of example by the following particular applications.

Transfer address 14 of a gas station or charging station, for example, could begin with the digit sequence 498001, which is linked to the following expectations: The tank fill level or battery charge level is to have increased shortly prior to a payment to this address 14; the tank cap is to be opened at this time or the charging plug is to have been inserted; and the driving speed during this time is to have been 0 km/h.

In contrast, transfer address 14 of a drive-in could begin with digit sequence 498003, which is linked to the following expectations: vehicle 30—more precisely, one of its windows or one of it doors—is to have been opened shortly prior to payment transaction 16 to this address 14 and the driving speed during this time is to have been 0 km/h.

Transfer address 14 of an expressway toll station could accordingly begin with the digit sequence 498005, which is assigned the following expectations: vehicle 30 drove over long distances in the same direction prior to a payment 16 to this address 14 and its steering angle over long distances was minimal, whereby large steering angles could be equally compensated for by changing lanes. This “lane change compensation” may be achieved by averaging the steering angle over a sliding time window of multiple seconds. The steering angle quasi filtered in this manner should, according to expectation, not have exceeded a threshold value over long distances before a payment 16 is directed to address 14 of the toll station.

Transfer address 14 of a parking facility may begin with the digit sequence 498007, which is linked to the expectation that vehicle 30 has been parked and locked prior to a payment 16 to this address 14.

Finally, transfer address (14) of a provider of road condition data or hazard data could begin with the digit sequence 498009, which is assigned the expectations that vehicle (30) received relevant road condition data or hazard data immediately prior to a payment (16) to this address (14).

A transfer limit and a maximum frequency for transfers may also be established as additional expectation values for all digit sequences or payment categories.

In addition, a location reference may be checked or a call number may be coded using the digits of transfer address 14, with which the plausibility of the authorization of payment transaction 16 is additionally checked. For this purpose, the digit sequence should be defined by position within address 14 in such a way that additional partial digit sequences of the same allow a corresponding check. If the values actually measured by HW wallet 20 meet the expectation values (branch Y—FIG. 1), then the HW wallet carries out the transfer (process 13—FIG. 1).

The method steps and considerations described by way of example for paying with a vehicle 30 may be similarly applied to paying with the aid of smartphones, computers, GPS receivers, automotive diagnostic units, or other mobile devices without departing from the scope of the present invention.

What is claimed is:

1. A method for processing a payment transaction using a cryptocurrency wallet to a payee having a predefined address, comprising:
calling up an operating state profile of a vehicle;
subjecting the address to a plausibility check based on the operating state profile; and
granting a release of the payment transaction when the address bears up against the plausibility check.

2. The method as recited in claim 1, further comprising:
when the release is granted, performing by the wallet a transaction calculation based on the address and on the released payment transaction.

3. The method as recited in claim 1, further comprising:
exchanging the payment transaction and the address between the wallet and the vehicle via a wireless interface; and
exchanging the payment transaction and the address between the vehicle and a cloud via a wireless interface.

4. The method as recited in claim 1, further comprising:
operating the vehicle to perform a buyer function, the payee performing a corresponding seller function in a cloud;
generating the address of the payee by repeatedly ascertaining a scatter value of different random numbers and of a secret key; and
using the scatter value as the address when the scatter value codes, according to a predefined scheme, the operating state profile of the vehicle typical for a performance of the buyer function.

5. The method as recited in claim 4, wherein:
the address is numerical, and
the scatter value codes the operating state profile according to the scheme when a partial digit sequence of a polyadic representation of the address established by position codes the operating state profile.

6. The method as recited in claim 5, wherein at least one of the following seller functions of the payee is assigned a fixed value of the partial digit sequence:
a gas station,
a charging station,
a toll station,
a parking facility. or
a data provider.

7. The method as recited in claim 6, wherein the operating state profile takes a past value of at least one of the following operating states of the vehicle into account:
a tank fill level
a battery charge level,
a driving speed,
a state of a door
a position of a window,
a driving direction,
a steering angle,
a parking time, or
a locked state.

8. A computer program configured to carry out a method for processing a payment transaction using a cryptocurrency wallet to a payee having a predefined address, the method comprising:
calling up an operating state profile of a vehicle;
subjecting the address to a plausibility check based on the operating state profile; and
granting a release of the payment transaction when the address bears up against the plausibility check.

9. A machine-readable memory medium, on which a computer program is stored and configured to carry out a method for processing a payment transaction using a cryptocurrency wallet to a payee having a predefined address, the method comprising:
calling up an operating state profile of a vehicle;
subjecting the address to a plausibility check based on the operating state profile; and
granting a release of the payment transaction when the address bears up against the plausibility check.

10. A device configured to carry out a method for processing a payment transaction using a cryptocurrency wallet to a payee having a predefined address, the method comprising:
calling up an operating state profile of a vehicle;
subjecting the address to a plausibility check based on the operating state profile; and
granting a release of the payment transaction when the address bears up against the plausibility check.
